(19) United States
(12) Patent Application Publication
(10) Pub. No.: US 2012/0170440 A1
(43) Pub. Date: Jul. 5, 2012

(54) ELECTROMAGNETIC ACTUATOR OF OPTICAL PICKUP HEAD

(75) Inventors: Tsung-Kai Chang, Hsinchu (TW); Ping-Ju Chang, Changhua (TW)

(73) Assignee: TopRay Technologies, Inc., Hsinchu City (TW)

(21) Appl. No.: 13/225,765

(22) Filed: Sep. 6, 2011

(30) Foreign Application Priority Data
Dec. 31, 2010 (TW) 099225755

(51) Int. Cl. G11B 7/135

(52) U.S. Cl. 369/112.23; G9B/7.121

(57) ABSTRACT

An electromagnetic actuator is provided, including a movable part and a base part. The movable part further includes at least an object lens, an object lens holder, a wire set, a first focus coil set, a second focus coil, a tilt coil set, and a track coil set. The object lens is placed inside object lens holder. One end of the wire set is fixed to object lens holder, and the other end is fixed to the base part so that the wire set is like a suspending wire set for hanging the object lens holder. The base part further includes a focus magnet set, a track magnet set and a tilt and focus shared magnet. The first focus coil set is located to correspond to focus magnet set, and the track coil set is located to correspond to the track magnet set, a second focus coil and a tile coil set in side-by-side layout are located to correspond to the tilt and focus shared magnet. When the current runs through the coils, the interaction of the poles of the magnets will cause the movable part to move in three different directions.

### FIELD OF THE INVENTION

The present invention generally relates to an electromagnetic actuator of optical pickup head.

### BACKGROUND OF THE INVENTION

The Blu-ray system has effectively improved the capacity of optical storage device in recent years. However, due to the limiting barrier of diffraction, Blu-ray system must use independent lens system from the DVD and CD systems to co-exist in an optical storage device. In addition, because of the requirements of accessing and recording of the optical storage device, the lens must follow with high sensitivity to match the errors caused by the manufacturing and rotation of the disc. In general, multi-axes voice coil motor (VCM) is used as the actuator for executing the above operation. FIG. 1 shows a schematic view of a conventional actuator. As shown in FIG. 1, four coils 14 are placed correspondingly to four magnets 13. When currents run through coils 14, the interaction between coils 14 and magnets 13 will induce a Z-direction magnetic force to move movable part 12 for focusing movement. The direction of focusing movement is the optical axis parallel to object lens 11. Coil 17 is placed in the gap between magnet 16 and magnet 18. When the currents run through coil 17, the interaction between coil 18 and magnets 16, 18 will induce a Y-direction magnetic force to move movable part 12 for tracking movement. The direction of tracking movement is the optical axis perpendicular to object lens 11.

### SUMMARY OF THE INVENTION

The primary object of the present invention is to provide an electromagnetic actuator for optical pickup head. A movable part of the actuator includes a lens holder for holding at least an object lens, a set of wires connected to the lens holder, and a base for lens holder to be hanged on the wire set to form a suspended object. The base further includes a set of focus magnets having coplanar bipolar magnets with different poles at the top and the bottom, a set of track magnets with different poles on the right and the left, and a tilt and focus shared magnet with different poles at the top and the bottom. The lens holder further includes a set of first focus coils, located at the position corresponding to the focus magnet set, and a set of second focus coils and a title coil, located at the position corresponding to the tilt and focus shared magnet.

The actuator of the present invention uses a plurality of magnets to be fastened to the base. Each magnet is placed in the coplanar bipolar manner so that a single magnet can form a semi-closed magnetic circuit system to enhance the magnetic flux density. The placement of magnets, interacting with the coils, can effectively improve the efficiency of the coils. In addition, focus coils and tilt coils can share a magnet to reduce the number of magnets used in the present invention so as to reduce the manufacturing cost.

The present invention provides an electromagnetic actuator able to move in three different directions for controlling the projection angle of the laser light source of the optical pickup head to achieve fast and precise data reading and writing. The present invention is able to compensate the errors caused by manufacturing to meet the requirements of reading and recording data by the optical storage device.

The advantages of the present invention includes:
1. The bipolar magnet design can greatly improve the efficiency of coils.
2. The tilt coil and the focus coil share a magnet to reduce the number of magnets.
3. The triangular placement of the focus magnets simplifies the coil sets.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a conventional electromagnetic actuator;

FIG. 2 shows a schematic view of details of the electromagnetic actuator according to the present invention;

FIG. 3 shows a schematic view of the electromagnetic actuator after assembly according to the present invention;

FIG. 4 shows a schematic view of an embodiment of the coplanar bipolar magnet set and coil set according to the present invention;

FIGS. 5A-5C show schematic views of embodiments of second focus coil, tilt coil set, and tilt and focus shared magnet according to the present invention; and

FIGS. 6A-6B show schematic views of embodiments of track magnet set and track coil set according to the present invention.

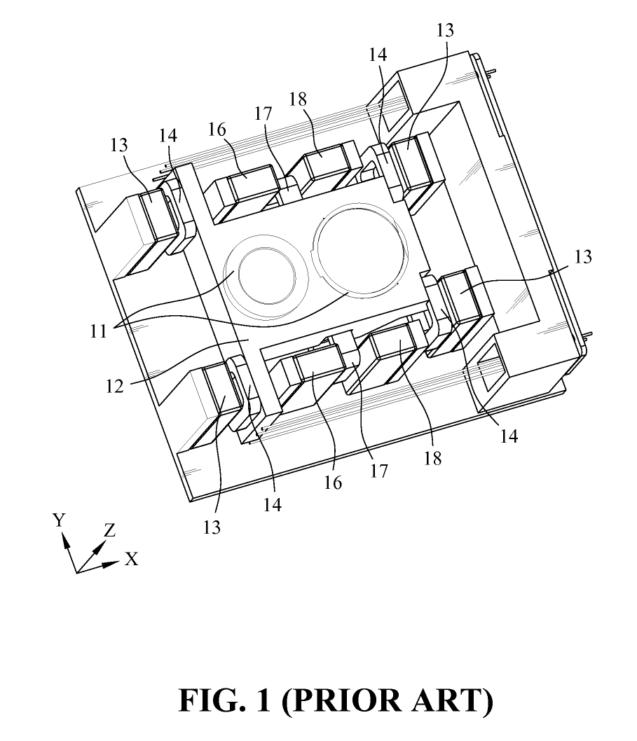

### DETAILED DESCRIPTION OF THE PREFERRED EMBODIMENTS

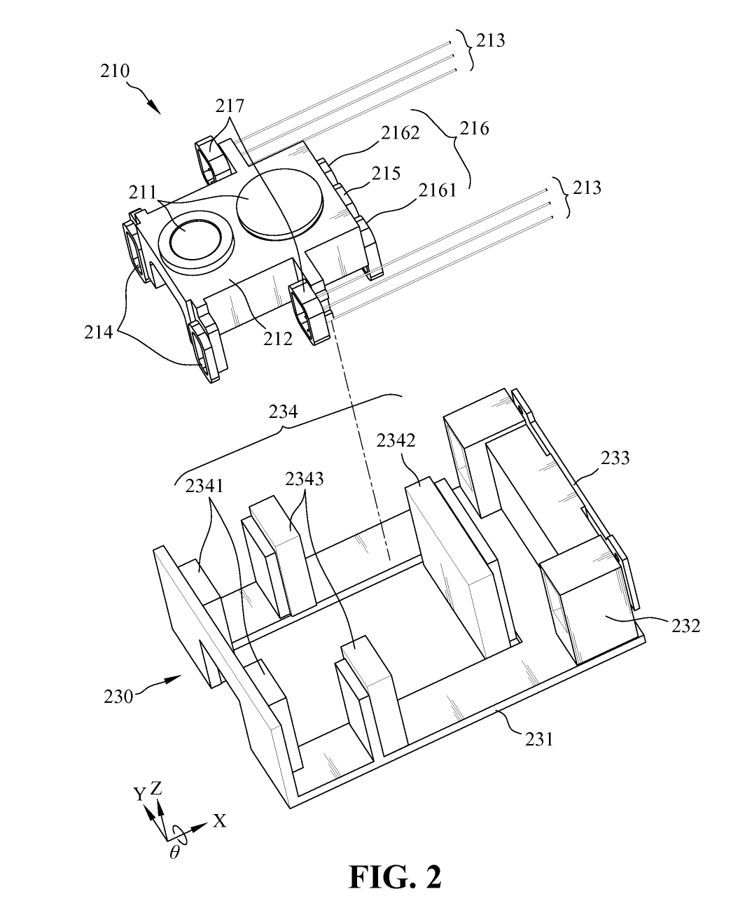

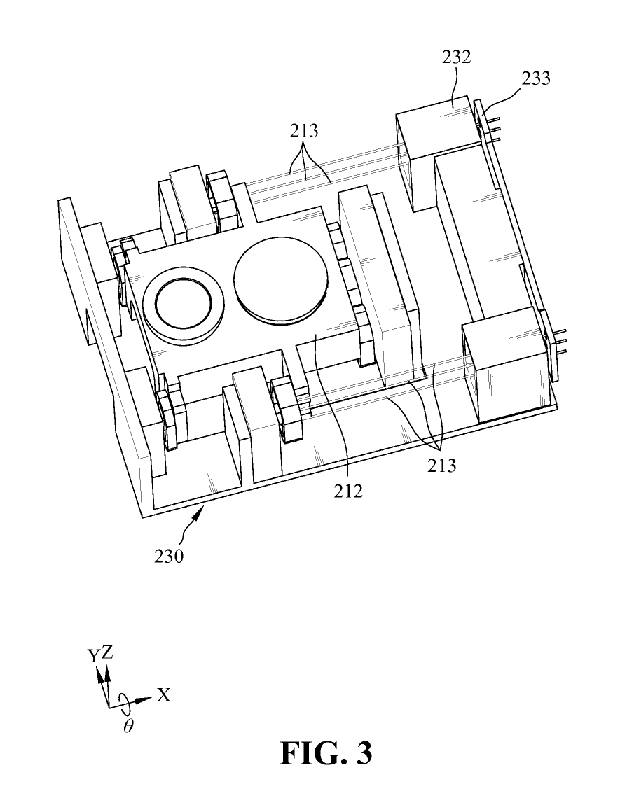

Refer to both FIG. 2 and FIG. 3. FIG. 2 shows a schematic view of the actuator of the present invention prior to assembly, and FIG. 3 shows a schematic view of the assembled actuator of the present invention. As shown in FIG. 2, electromagnetic actuator includes a movable part 210 and a base part 230. Movable part 210 further includes at least an object lens 211, an object lens holder 212, a wire set 213, a first focus coil set 214, a second focus coil 215, a tilt coil set 216, and a track coil set 217. Object lens 211 is placed inside object lens holder 212, and is able to emit and receive laser light. One end of wire set 213 is fixed to object lens holder 212, and the other end is fixed to a damper holder 232 of base part 230 and also connected to a circuit board 233 on base part 230. Therefore, wire set 213 is like a suspending wire set for hanging object lens holder 212 so that object lens holder 212 can move along three different axes, as shown in FIG. 3. Track coil set 217 is fixed to the two sides of the central part of object lens holder 212. First focus coil set 214 is fixed to the front of object lens holder 212, and second focus coil 215 and tilt coil set 216 are fixed to the same plane at the back of object lens holder 212 for side-by-side layout. Tilt coil set 216 includes a first tilt coil 2161 and a second tilt coil 2162. Second focus coil is located between first tilt coil 2161 and second tilt coil 2162. The aforementioned three axes for movement include a focus movement (Z-direction), a track movement (Y-direction) and a tilt movement (θ direction, rotation surrounding X-direction).

Base part 230 includes a yolk 231, a damper holder 232, a circuit board 233 and a plurality of coplanar bipolar magnet sets 234. Damper holder 232, circuit board 233 and coplanar bipolar magnet sets 234 are all fixed on yolk 231. Coplanar bipolar magnet sets 234 further includes a focus magnet set 2341, a tilt and focus shared magnet 2342, and a track magnet set 2343. Focus magnet set 2341 is fixed to the front area of yolk 231, with location corresponding to first focus coil set 214. Tilt and focus shared magnet 2342 is fixed to the back area of yolk 231, with location corresponding to second focus coil 215 and tilt coil set 216. Track magnet set 2343 is fixed to the central area of yolk 231, with location corresponding to track coil set 217.

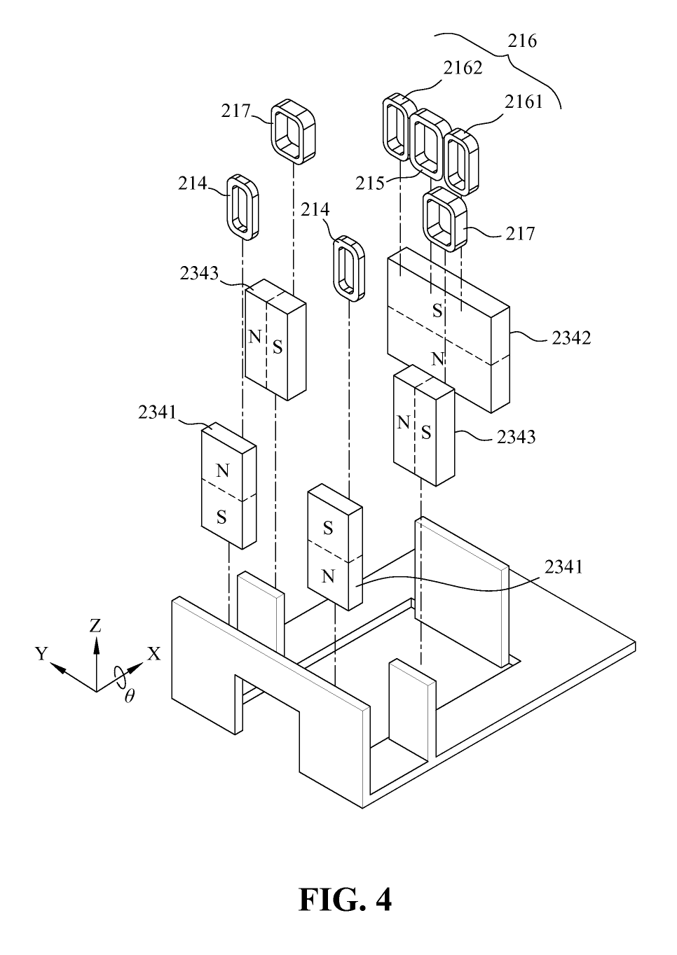

FIG. 4 shows a schematic view of an embodiment of the coplanar bipolar magnet sets and coil sets according to the present invention. As shown in FIG. 4, focus magnet set 2341 and tilt and focus shared magnet 2342 have different poles on the top and bottom surfaces. Focus magnet set 2341 corresponds to first focus coil set 214, and tilt and focus shared magnet 2342 corresponds to second focus coil 215 and tilt coil set 216. When the current runs through first focus coil set 214 and second coil set 215, a force in the focus direction (Z) is induced to move object lens holder 212 along Z direction. When the current runs through tilt coil set 216, a force in the tilt direction (θ) is induced to move object lens holder 212 along θ direction. Track coil set 217 corresponds to track magnet set 2343 having different poles on left and right surfaces. When the current runs through track coil set 217, a force in the track direction (Y) is induced to move object lens holder 212 along Y direction. First focus coil set 214 and second focus coil set 215 are fixed to the front and back areas of object lens holder 212, forming a layout of a triangle to as to improve the stability and precision during the focus movement of object lens holder 212.

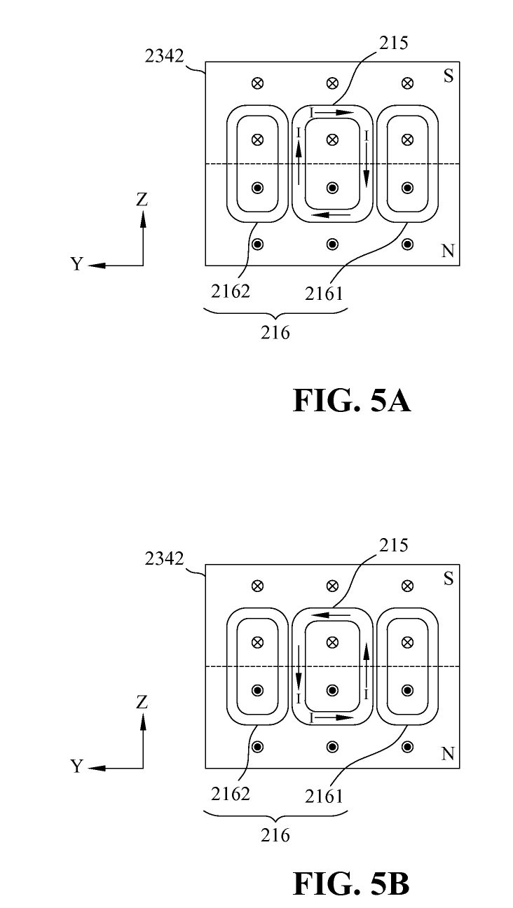

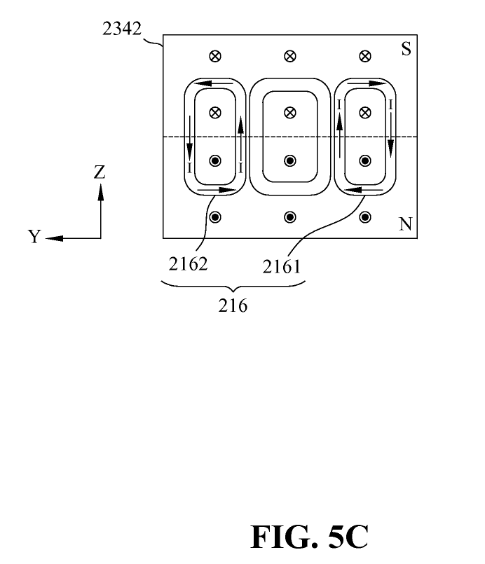

FIG. 5A-FIG. 5C show schematic views of embodiments of second focus coil, tilt coil set, and tilt and focus shared magnet according to the present invention. As shown in FIG. 5A, second focus coil 215 and tilt coil set 216 correspond to tilt and focus shared magnet 2342 with different poles on top and bottom surfaces, and are distributed symmetrically between the two poles. The upper half of tilt and focus shared magnet 2342 of the present embodiment is S pole, and the lower half is N pole. The range of the magnetic force is around second focus coil 215 and tilt coil set 216. The effect of S pole of tilt and focus shared magnet 2342 is perpendicularly emitting into the paper, and is distributed in the upper half of second focus coil 215. The effect of N pole of tilt and focus shared magnet 2342 is perpendicularly emitting from the paper, and is distributed in the lower half of second focus coil 215. When the current I runs along the direction indicated by the arrow (clockwise) in second focus coil 215, a magnet force in the Z direction can be induced by the N and S poles of tilt and focus shared magnet 2342 so as to move for focus purpose. On the other hand, as shown in FIG. 5B, when the current I runs along the direction indicated by the arrow (counterclockwise) in second focus coil 215, a magnet force in the −Z direction can also be induced by the N and S poles of tilt and focus shared magnet 2342 so as to move for focus purpose.

As shown in FIG. 5C, when the current I runs along the direction indicated by the arrow (clockwise) in first tilt coil 2161, a magnet force in the +Z direction can be induced by the N and S poles of tilt and focus shared magnet 2342. On the other hand, when the current I runs along the direction indicated by the arrow (counterclockwise) in second tilt coil 2162, a magnet force in the −Z direction can be induced by the N and S poles of tilt and focus shared magnet 2342. Because first tile coil 2161 and second tilt coil 2162 are located on different sides of movable part 210, the result can force object lens holder 212 (not shown in FIG. 5C) to rotate, and the rotation direction is the tilt movement.

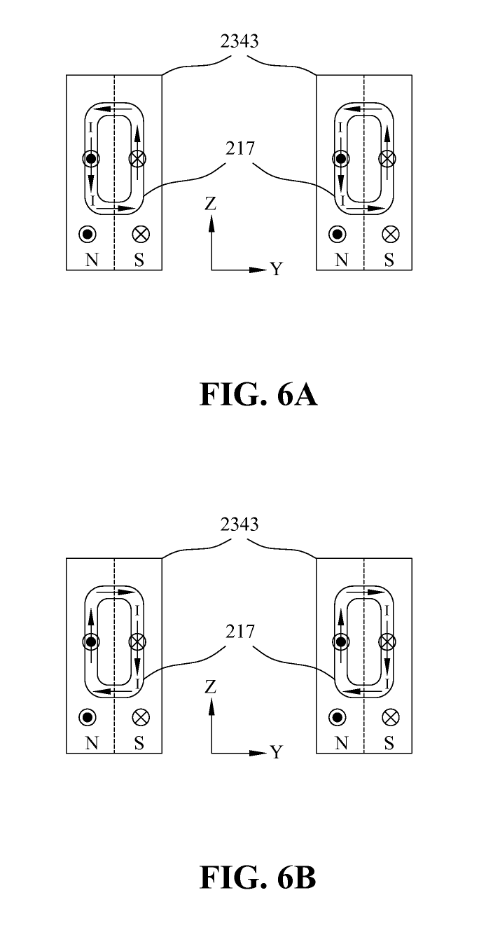

FIG. 6A and FIG. 6B show schematic view of embodiments of track magnet set and track coil set according to the present invention. As shown in FIG. 6A, track coil set 217 correspond to track magnet set 2343 with different poles on left and right surfaces, and is distributed symmetrically between the two poles. The left half of each magnet of track magnet set 2343 of the present embodiment is N pole, and the right half is S pole. The range of the magnetic force is around track coil set 217. The left half of track coil set 217 is located within the effect range of N pole of track magnet set 2343, and the magnetic field from N pole emits perpendicularly from the paper. When the current I runs along the direction indicated by the arrow (counterclockwise) in track coil set 217, a magnet force in the −Y direction can be induced by the N pole of track magnet set 2343. The right half of track coil set 217 is located within the effect range of S pole of track magnet set 2343, a magnet force in the −Y direction can be induced by the S pole of track magnet set 2343. Then, the left half and right half can both execute track movement at the same time. On the other hand, as shown in FIG. 6B, when the current I runs along the direction indicated by the arrow (clockwise) in track coil set 217, the right half of track coil set 217 is located within the effect range of S pole of track magnet set 2343 and the left half of track coil set 217 is located within the effect range of N pole of track magnet set 2343 a magnet force in the Y direction can be induced by the N pole of track magnet set 2343. A magnet force in the Y direction can be induced in the left half and the right half of track coil set 217 at the same time. Therefore, the left half and right half can both execute track movement at the same time.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electromagnetic actuator for optical pickup head, comprising:
a movable part, further comprising at least an object lens, an object lens holder, a wire set, a first coil focus et, a second focus coil, a tilt coil set, and a track coil set, said object lens being placed inside said object lens holder, and being able to emit and receive laser light, one end of said wire set being fixed to said object lens holder, and the other end being fixed to a damper holder and also connected to a circuit board, therefore, said wire set being like a suspending wire set for hanging said object lens holder so that said object lens, holder being able to move along three different axes, said track coil set being fixed to two sides of central part of said object lens holder, said first focus coil set being fixed to front area of said object lens holder, and said second focus coil and said tilt coil set being fixed to same plane at back area of said object lens holder for side-by-side layout, said tilt coil set further comprising a first tilt coil and a second tilt coil, said second focus coil being located between said first tilt coil and said second tilt coil; and
a base part, further comprising a yolk, said damper holder, said circuit board and a plurality of coplanar bipolar magnet sets, said damper holder, circuit board and coplanar bipolar magnet sets being all fixed on said yolk, said coplanar bipolar magnet sets further comprising a focus magnet set, a tilt and focus shared magnet, and a track magnet set, said focus magnet set being fixed to front area of said yolk, with location corresponding to said first focus coil set, said tilt and focus shared magnet being fixed to back area of said yolk, with location corresponding to said second focus coil and said tilt coil set, said track magnet set being fixed to central area of said yolk, with location corresponding to said track coil set;
wherein said first focus coil set and said second focus coil set respectively corresponding to said focus magnet set and said tilt and focus shared magnet, and when a current running through said first focus coil set and said second focus coil, a force to cause focus movement in Z direction being induced;
said track coil set corresponding to said track magnet set, and when a current running through said track coil set, a force to cause track movement in Y direction being induced; and
said tilt coil set corresponding to said tilt and focus shared magnet, and when a current running through said tilt coil set, a force to cause tilt movement in θ direction being induced to rotate around X direction.

2. The electromagnetic actuator as claimed in claim 1, wherein said focus magnet set has different poles on top and bottom surfaces.

3. The electromagnetic actuator as claimed in claim 1, wherein said tilt and focus shared magnet has different poles on top and bottom surfaces.

4. The electromagnetic actuator as claimed in claim 1, wherein said track magnet set has different poles on left and right surfaces.

5. The electromagnetic actuator as claimed in claim 1, wherein locations of said first focus coil set and said second focus coil being fixed on said yolk form a triangle.
